(19) United States
(12) Patent Application Publication
(10) Pub. No.: US 2014/0207669 A1
(43) Pub. Date: Jul. 24, 2014

(54) Smart Electronic Wallet

(71) Applicant: Einar Rosenberg, Miami Beach, FL (US)

(72) Inventor: Einar Rosenberg, Miami Beach, FL (US)

(21) Appl. No.: 14/163,329

(22) Filed: Jan. 24, 2014

Related U.S. Application Data
(60) Provisional application No. 61/755,978, filed on Jan. 24, 2013.

(51) Int. Cl. G06Q 20/36

(52) U.S. Cl. CPC G06Q 20/36
USPC 705/41

(57) ABSTRACT

A method for helping a consumer select an advantageous method of paying for a transaction. By providing a consumer with advantages and/or disadvantages of each payment method, the user can select a payment option while reviewing potential outcomes of the using different payment options.

### CROSS REFERENCE TO RELATED APPLICATION

This application claims the benefit of U.S. provisional patent application No. 61/755,978, filed Jan. 24, 2013, the disclosure of which is incorporated herein by reference in its entirety.

### BACKGROUND OF THE INVENTION

Every year, more and more people carry mobile communication devices, e.g., smartphones (e.g., iPhones®, Razrs®, Galaxys®, Moto®, etc.), tablets (e.g., iPads®, Kindles®, Venues®, Surfaces®, etc.), etc. One of the many features that is or can be incorporated into a mobile communication device is an electronic wallet (e.g., A storage medium, typically encrypted, for storing credit card and/or other financial information that can be used to complete an electronic transaction without having to enter the stored data at the time of the transaction.”) With the ease, simplicity and reasonably seamless operation of an electronic wallet to assist in the completion of an electronic transaction, there is an increasing reliance on the use of electronic wallets. Not surprisingly, more and more consumers are using their mobile communications devices to pay payment for purchases using payment information stored on their mobile communication device.

As consumers typically have personally available more than one option of payment that they do or can use, they will likely store more than one payment option in their electronic wallet of their mobile communication device. However, when consumers have more than one payment option available, the consumer usually has a default—a “go to” option. In some situations, a user has two “go to” options—one for business transactions and one for his personal transactions. For example, for business expenses, the consumer would use the business credit card, e.g., an American Express® card, and for personal use, the consumer would use his Pentagon Credit Union® credit card.

The average consumer in the United States has sixteen different payment options—cards ranging from Credit Cards, Debit Cards, Gift Cards, Prepaid Cards, Store Cards, to Loyalty/Payment Cards and more. Due to digital issuance, we are likely to see the number of sixteen payment cards increase. With the increasing popularity of the electronic wallet for mobile payment, we can expect that the number of payment options will only increase in a person's wallet. Although a consumer might have multiple payment options, e.g., sixteen credit cards, the consumer typically does not carry them all with them in their physical wallet—mostly because it is inconvenient to carry many cards around. With an electronic wallet in a mobile communication device, consumers will not be inconvenienced to carry many more if not all of their cards.

Each type of payment option has an advantage(s), or conversely a disadvantage, which consumers may or may not even realize. It would be of great benefit for consumers have a system to help them decide at the time of purchase if there is an advantage(s) (or disadvantage) to using one payment option over another.

Furthermore, many consumers have coupons that they receive, but forget to use them or can't find them. It would be desirable for consumers have a system to present them with coupon options at the time of purchase if a coupon is applicable and appropriate.

### BRIEF DESCRIPTION OF THE DRAWINGS

FIG. 1 depicts a payment scenario according to an exemplary embodiment of the invention;

FIG. 2 depicts an exemplary payment option database;

FIG. 3 depicts an exemplary flowchart of the use of the method of providing payment options according to an exemplary embodiment of the invention;

FIG. 4 depicts an exemplary coupon database;

FIG. 5 depicts an exemplary flowchart of the use of the method of providing payment options according to another exemplary embodiment of the invention;

FIG. 6 depicts a payment scenario according to an exemplary embodiment of the invention;

FIG. 7 depicts an exemplary flowchart of the use of the method of determining the results of using a payment option according to an exemplary embodiment of the invention;

FIG. 8 depicts another exemplary payment option database; and

FIG. 9 depicts an exemplary payment option results database.

### DETAILED DESCRIPTION OF THE INVENTION

In the following detailed description, reference is made to the accompanying drawings, which form a part hereof, and in which is shown by way of illustration specific exemplary embodiments of the invention. These embodiments are described in sufficient detail to enable those of ordinary skill in the art to make and use the invention, and it is to be understood that structural, logical, or other changes may be made to the specific embodiments disclosed without departing from the spirit and scope of the present invention.

The invention discloses a system and method to help a consumer decide at the time of purchase if there is an advantage to using one payment option over another(s).

In another aspect, the invention discloses a system and method to help a consumer decide at the time of purchase if there is an advantage to using one payment option over another(s) and then assists the consumer in making the payment.

In an in-person sales transaction, a user enters a store, selects an item(s) and then to complete the transaction, the user pays for the item. As part of the transaction the user must decide how to pay for the transaction. Most users have a plurality of options for payment. Therefore it is advantageous to determine at least at the time of the sales transaction which payment option the user should select to pay for the sales transaction, Although exemplary use of the invention is described with respect to in-person sales transaction, and the invention is not so limited; for example, the invention is also applicable to sales transactions that do not occur in-person, e.g., over the phone or through the Internet.

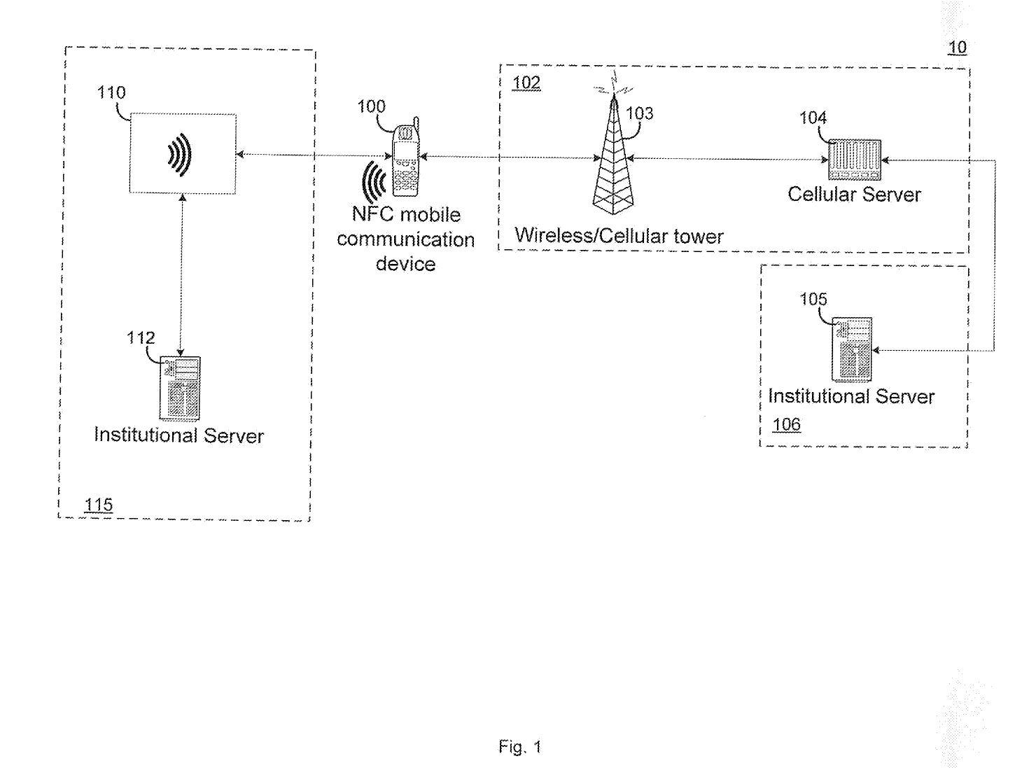

FIG. 1 depicts a payment scenario according to an exemplary embodiment of the invention. As depicted in FIG. 1, a user with a NI C enabled mobile communication device 100 having an electronic wallet with payment options enters a store. The user selects an item(s) and then starts the payment transaction process. As part of the payment transaction process, the user must provide or present a method of payment. The user uses his mobile communication device 100 that assists the user in selecting the payment option from his available payment options and the user selects his payment option for payment processing. In an aspect, once the user has selected the payment option that he wants to use to pay for the transaction by providing an appropriate input to the user's mobile communication device 100, the user's mobile communication device 100 electronically provides to the store payment information associated with the selected payment option. In another aspect, the mobile communication device 100 assists the user in selecting the payment option and the user manually provides that information to the store, e.g., by handing the credit card of the selected payment option to the cashier. The selection of payment the user's selected payment option is described in more detail below. Assuming that the payment has been accepted, i.e., the payment processing results in the store receiving payment or its equivalent, then the payment transaction process is substantially completed.

An exemplary embodiment of the invention is depicted in FIG. 1 which shows a a mobile communication device 100, a cellular service 102 which includes a cellular tower 103 and a cellular server 104, an institutional server 105 of an institution 106, an institution 115, a POS terminal 110, and an institutional server 112.

The mobile communication device 100 includes at least NFC communication abilities and cellular communication abilities. The mobile communication device 100 communicates with its associated cellular service 102 using its cellular server 104 (i.e., cellular computer system) through a tower 103. Although shown as a single tower 103, this is representational of a single or network of tower systems associated with a cellular service associated with the mobile communication device 100. Although shown as a single cellular server 104, this is representational of a single or network of cellular servers associated with a cellular service associated with the mobile communication device 100.

Institution 115 is for example, a store, is representational of a transaction party that is interacting with a consumer through the consumer's mobile communication device 100 to conduct a transaction—e.g., a purchase of an item(s). Institution 115 includes at least one FOS terminal 110 which includes NFC capabilities. The POS terminal 110 communicates with an institutional server 112. Although shown as a single POS terminal 110, this is representational of a single or network of POS terminals associated with the institution 115. Although shown as a single institutional server 112, this is representational of a single or network of institutional servers associated with the institution 115. The institution's computer system includes, at least, server 112 and terminal 110.

Institutional server 105 is a server associated with an institution 106. Typically, an institution 106 is uniquely associated with a payment option of the consumer. Although shown as a single institutional server 105, this is representational of a single or network of institutional servers associated with an institution 106 or multiple institutions 106. Art institutional 106 could be the same or different from institution 115, depending on the transaction. This is described u greater detail below.

In a preferred approach, a mobile communication device 100 includes an electronic smart wallet app. This app can be installed by the factory, downloaded from an app store, or any other reasonable method of transferring a copy of the app program to the mobile communication device 100. The smart wallet app has at least two main features: database management and purchase management. With respect to the database management, the smart wallet app manages a database of payment options and information about the payment options. The smart wallet app is, when appropriate and from time to time, updated to include improvements, bug fixes, and other possible changes.

The smart wallet app provides the ability to create, modify, and delete payment options in the smart wallet payment option database. Thus, when a user wants to add a new payment option, she utilizes the smart wallet app which will enable and/or guide her through adding a new payment option, which includes adding information about the payment option. In a preferred approach, payment option information, includes, for example, the name of the payment option, the type of payment option (for example, credit, debit, e-check,), and contact information for its associated intuitional server. Similarly, the smart wallet provides the ability to modify a current existing payment option and to delete a payment option from the database of the electronic smart wallet. In an aspect, depending on the settings established by the user or the software designer, the electronic smart wallet uses communication features of the mobile communication device 100 to respectively communicate with the institutional server associated with a payment option to receive information about the payment option. The information received is then stored in the smart wallet.

A second aspect of the electronic smart wallet is purchase management—the smart wallet determines which payment options are available. The smart wallet app also determines advantages and/or disadvantages of each payment option and provides that information to the user. In a preferred approach, once the users has started her transaction payment process at a store and the items have been totaled, the POS of the store communications purchase information to the electronic smart wallet through the features of the mobile communication device 100. The smart wallet determines which of the payment options are available and then provides the available payment options to the user. When the user selects a payment option on the smart wallet, then the smart wallet causes the mobile communication device 100 to provide account information of the selected payment option to the store through the POS 110 of the store 115. The POS 110 receives the user's account information and provides it to the server 112 for processing of the payment.

To determine the payment options to be presented to the user the smart wallet app goes through the database of payment options stored in the mobile communication device. For each payment option, the smart wallet determines attributes of each payment option. For example, the smart wallet app determines generic benefits from using payment option (i.e., benefits not linked to a transaction with a specific institution, but generally available during a transaction with any institution). Generic benefits include, but are limited to, discounts for using the payment option, coupons, motivational promotions. The smart wallet app also determines (current) outstanding balance or credit, if any, on a payment option. The smart wallet app also determines threshold on a payment option (and if purchase price has been received, whether intended transaction exceeds threshold), where the threshold has determined by the user or by the institution associated with the payment option. This attribute information is preferably stored locally on mobile communication device as part of payment options database.

In another aspect, the attribute information is accessed from the institution associated with the Payment option, and/or used in combination with information stored locally on the mobile communication device, through the Internet or other network system substantially at time of a transaction. In an aspect, this attribute information is updated periodically and/or substantially at time of a transaction. The group of available payment options is based on the group of payment options and then removing a payment option that is not accepted or exceed a threshold. The remaining members of the payment options are provided to the user.

In a preferred aspect, a user can define how information resulting from the smart wallet determining the advantages and the disadvantages is displayed. For example, the user requests that information be sorted and be displayed based on total cost (e.g., total purchase price minus any discounts or incentives), from lowest cost to highest. In another approach, the user requests that information be sorted and be displayed in order of motivational features, where the parameters of a motivational feature are/have been defined by the user or default.

In use, a consumer with a mobile communication device 100 desires to make a purchase from an institution 115. The consumer selects a payment option on his mobile communication device 100 and provides payment information to the institution by way of the consumer's mobile communication device 100 electronically communicating with the institution's POS terminal 110, preferably using NFC communications. Although referring to the use of NFC communications to exchange information, the invention is not so limited and other communications methods can be employed, including, but not limited to, short and/or long distance radio/optical communications. Furthermore, information can be entered manually by the user.

The smart wallet app receives purchase information which, in a preferred approach, provides an identification of the institution. The purchase information provides, in a preferred approach, benefits, advantages, disadvantages, and restrictions offered by the institution to the user in regards to general transactions and in regards to specific payment options.

In another approach, the smart wallet app, using the institution identification, contacts, if possibly, each institution associated with the payment option to determine, benefits, advantages, disadvantages, and restrictions offered by the institution of the payment option to the user in regards to a transaction with the intuition.

In order for a consumer to make a selection regarding a payment option using his mobile communication device 100, the mobile communication device 100 would preferably have payment options stored in an electronic data file in or associated with the smart wallet app, e.g., a mobile wallet, in the mobile communication device 100. In another aspect, the mobile communication device 100 would preferably have payment options stored in an electronic data file not stored on the mobile communication device 100, e.g., a virtual wallet accessed through a secure server. Thus, in a preferable approach, a consumer sets up payment options in the mobile communication device 100 at time before purchasing an item.

In an exemplary approach, a consumer can store in his mobile communication device 100 different payment options. For example, payment options can include: “bank” credit cards, e.g., American Express, Visa, MasterCard, Diners Club; store credit cards, e.g., Target, Sears, Bloomingdales, Williams and Sonoma; debit cards, e.g., PNC, Wells Fargo; gift cards; PayPal; Gift Cards, Pre-Paid Cards, Specialty Payment Cards, ACH Cards, and EFT/Digital Cash. For each payment option additional attributes—information—is stored. For example, the additional information is, for example, contact information of institution associated with the payment option, account information, usage information, store membership level, amount of cash remaining on debit account or gift card, and other data that can define information about that consumer, each specific payment option, and consumer behavior/history.

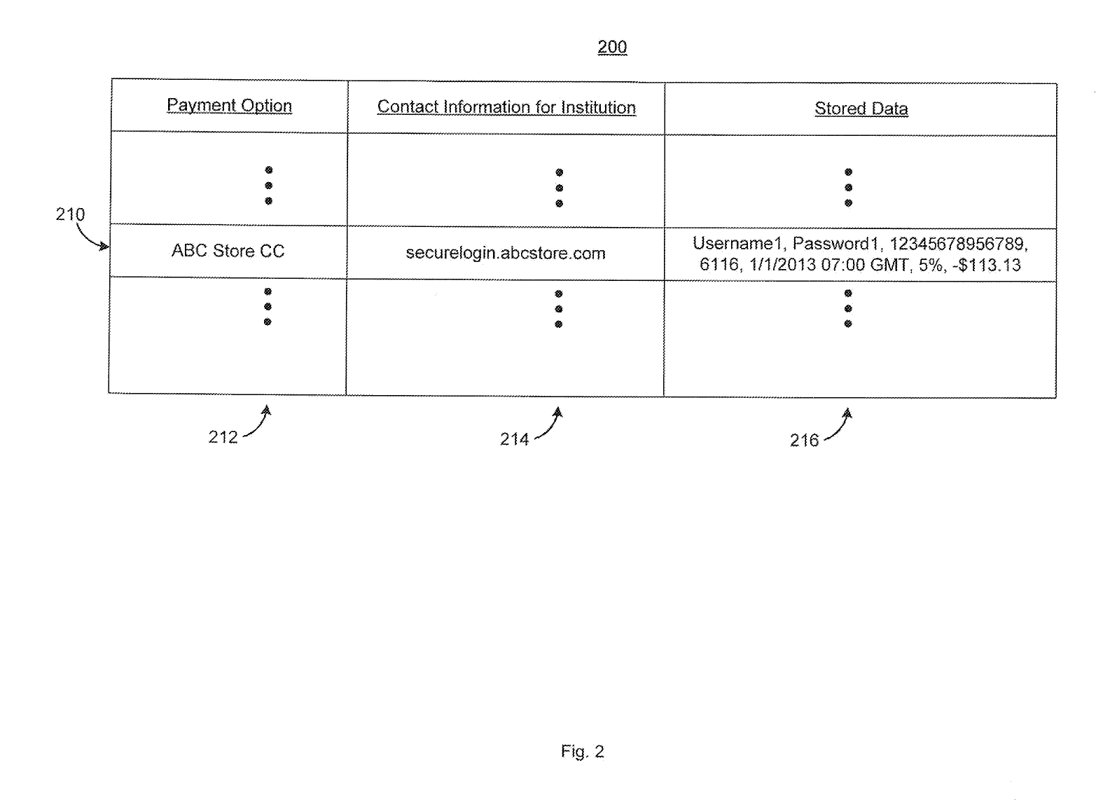

FIG. 2 depicts an exemplary payment option smart wallet database 200 that would be stored in a consumer's mobile communication device 100. Database 200 includes three data fields: payment option 212, contact information 214, and other stored data 216. For example, in data entry 210, the payment option is the ABC store credit card. The contact information for the institution 106 associated with the ABC store credit card is securelogin.abcstore.com for access through the Internet. In the stored data entry 210, a consumer has stored “Username1, Password1, 12345678956789, 6116, 1/1/2013 07:00 GMT, 5%, -$113.13” which respectfully represents for the credit card account the username, the password, the account number, the security tag number, the last time the mobile communication device 100 communicated and downloaded information from the account, the discount for using the ABC store card in an ABC store, and the outstanding balance on this account (as of the last download). Ideally, there is a data entry 210 for each payment option.

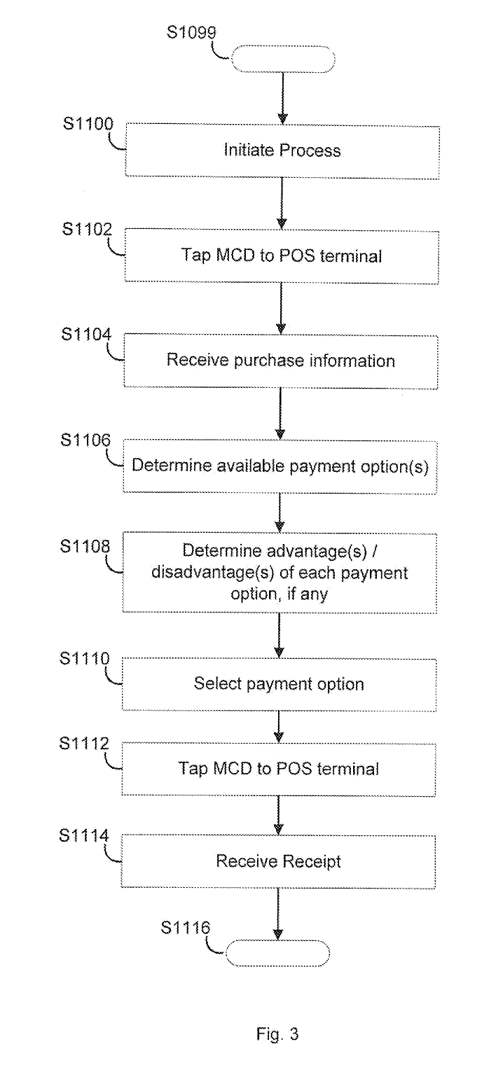

FIG. 3 is a flow chart depicting an exemplary use of the invention. In segment S1099, a consumer desires to conduct a sales transaction in an institution 115 and has selected the merchandise and the transaction is ready to be concluded by payment by the consumer. Process continues to segment S1100.

In segment S1100 the payment option selection process is initiated on the mobile communication device 100. The payment option selection process is a smart wallet application on the mobile communication device 100 for at least the purposes making a selection of a payment option in a sales transaction. The application is initiated either by the consumer performing some action on the mobile communication device 100 or by some automatic trigger, e.g., placing the NFC enabled mobile communication device 100 close to a NFC point of sale machine of an institution. Process continues to segment S1102.

In segment S1102, the consumer places the mobile communication device 100 sufficiently close to the POS terminal 110 of the institution 115 to establish communications. Process continues to segment S1104.

In segment S1104, the mobile communication device 100 receives purchase information from the institution 115. The purchase information includes, at least, purchase price. The purchase information could also include identification of the institution. Purchase information could also include payment options that are accepted and not accepted. In an approach, the mobile communication device 100 also receives payment benefits and restrictions. For example, American Express may not be accepted by the institution. In an approach the purchase information includes any discounts or motivational promotions, for example, coupons or loyalty points, that the consumer will receive if they decide to use one specific payment option they have available, versus another. Process continues to segment S1106.

In segment S1106 the smart wallet application goes through each payment option in the database 200 to see if it is available for purchase. For example, the smart wallet application determines if the balance on the payment option is acceptable. The smart wallet application may rely on information stored in the database or communicates with the institutional server 105 associated with the institution 106 of the payment option or a combination of both approaches to determine outstanding balance. Furthermore, the smart wallet application not only examines the current balance on the payment option, but also determines the balance after the transaction to see if that would result in exceeding a threshold. If the balance exceeds a certain threshold, then the payment option is made not available; otherwise, it should be available for use. The smart wallet application may also rely on purchase information received from the institution 115. If the purchase information indicates that a payment option is not available, then the payment option is not available; otherwise, if the balance has not exceeded a threshold, then the payment option should be available for use. Process continues to segment S1108.

In segment S1108 the smart wallet application determines whether there is an advantage or disadvantage to using each of the available payment options for the purchase and informs the consumer of the advantages and disadvantages. An advantage/disadvantage may be general or specific to the store. For example, using an American Express payment option may provide frequent flyer miles (in an amount of X miles) or in that specific store, a purchase can represent double miles. Furthermore, American Express may, at the time of purchase, have a special relationship with the ABC store and therefore also offer 5% cash back on the purchase. Moreover, the consumer may have a gift card for ABC store that expires soon. Additionally, the store may have a better transaction rate with one payment option available in the consumers phone, so it may offer a discount or benefit if the consumer uses a specific card that benefits that store, versus any other payment option the consumer may have in their smart wallet. In an approach, the smart wallet combines uses of payment options, such as using the remainder of a store gift card with a second payment option to complete the amount required for the current purchase amount. In another embodiment, the store can offer an automatic sign up and issuance of a payment option such as a store credit card, which then can be accepted and added to the consumers wallet payment options. Similar to how, for example, at Macy's, a consumer can be offered a 10% discount if they sign up right then and there, for a Macy's credit card to be used for that specific purchase or all purchase made on that day. After determining any advantage/disadvantage for each payment option, process continues to segment S1110.

In segment S1110, the consumer selects a payment option. This payment option is the one recommended to the consumer or is any payment option the consumer has available that can be used in that store for that specific purchase at that moment. The smart wallet recommends and informs the benefit to the consumer of using a specific payment option, but the consumer has the freedom to use which ever payment option they wish, which is available. The smart wallet can also incorporate intelligent restrictions, such as if the consumer implements a spending habit cap, a financial institution has imposed a spending behavior limit to aid in reducing expenditures or additional expanding debt of that institutions payment option, or other programs and services that help reduce or block purchases of specific amounts or for specific items or types of stores. Another example of restriction is a parent giving their child a payment option on the child's smart wallet, where it can restrict that child from using the payment option for purchases above a restricting amount, or restrict the child from using the payment option in store locations that are restricted such as a liquor store, or a clothing store. The smart wallet can also contact a third party such as an institution, parent, or other party, to allow access to a specific payment option or to remove a block from a currently blocked payment option. Process continues to segment S1112.

In segment S1112, the consumer places the mobile communication device 100, for a second time, sufficiently close to the POS terminal 110 of the institution 115 to establish communications. As part of the communications, the mobile communication device 100 provides payment information, for the selected payment option which the consumer has selected from their smart wallet. This payment option can be the option recommended by the smart wallet application or another available option, for example, a payment option which has no restrictions on its use. Process continues to segment S1114.

In segment S1114, the institutional server 112 receives the payment account information, processes the payment and provides a receipt to the consumer through a designated method. Process continues to segment S1116.

In segment S1116, payment has been made and the process ends.

Thus, smart wallet app on the users' mobile communication device 100 has provided the user with available payment options, advantage/disadvantage of each payment option and the user has made a selection of the payment option to be used for the transaction based on the information provided by the smart wallet application and that payment option information was provided to the institution 115 so as to conclude the transaction.

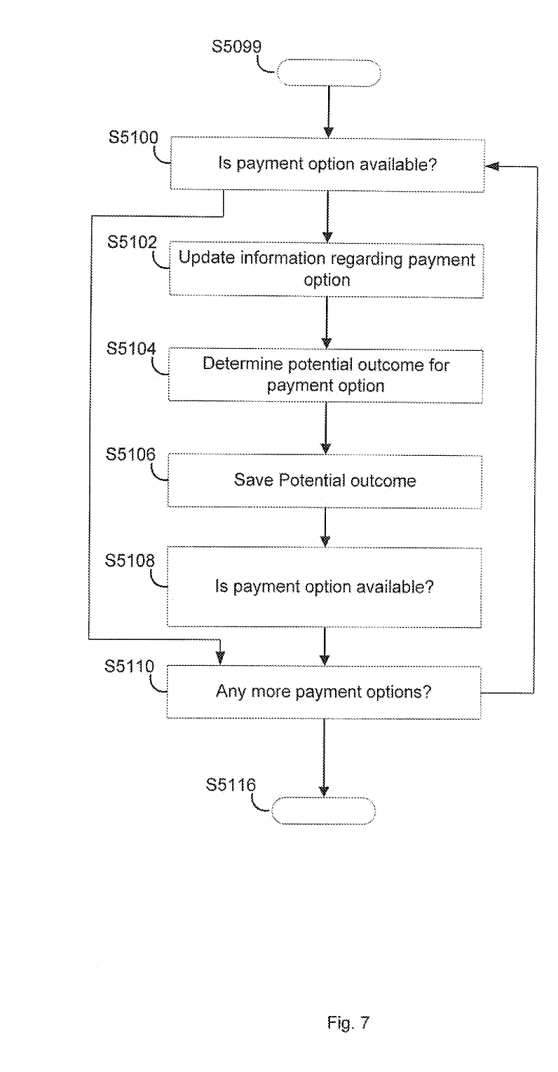

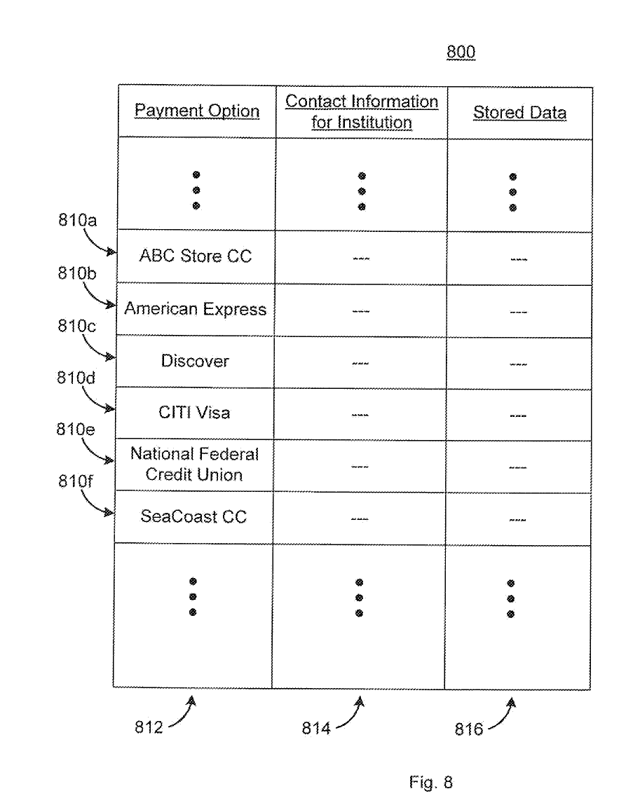

FIG. 7 depicts an exemplary approach to segments S1106 and S1108 of FIG. 3 in greater detail. FIG. 8 depicts another exemplary smart wallet database having several different payment options. Database 800 includes three data fields: payment option 812, contact information 814, and other stored data 816. Although data fields 814 and 816 are left blank in this example for simplicity, the field would preferably be populated with information, as depicted with respect to FIG. 2. Although database 800 includes six payment options, this database is intended to be representative of any number payment options, where the number is larger, smaller or the same.

As depicted in the process flow char of FIG. 7, for each payment option in the smart wallet database, the smart wallet app determines a potential outcome for each payment option being used as payment for the sales transaction. Assuming for the purposes of the discussion of FIGS. 7, 8, and 9, that a user is doing a sales transaction of $517.63 at store X, where store X does not accept American Express Credit cards, nor does it accept credit cards of other stores, e.g., ABC store CC.

In Segment S5099, the process begins and continues to segment 5100,

In Segment S5100, the application determines if the payment option is available. If the payment option is available, the process continues to segment S5102. If the payment option is not available, the process continues to segment S5108.

In S5102, the smart wallet app, in a preferred approach, contacts the institution associated with the payment option and updates it's associated attributes, if needed. For example, the app determines that the payment option has a different outstanding balance than currently reflected in the smart wallet database. Process continues to segment S5104.

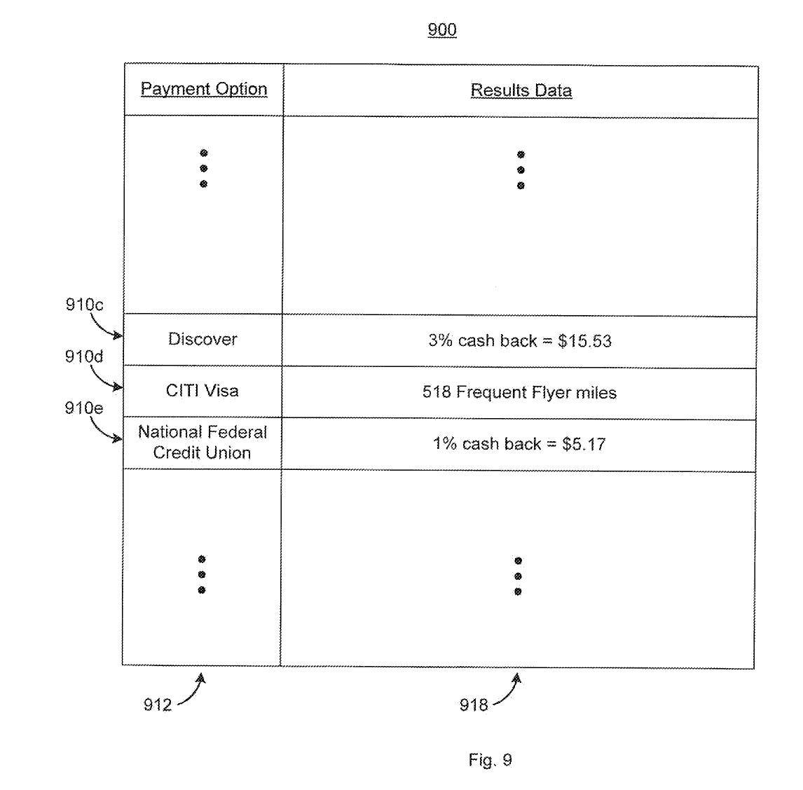

In Segment S5104, the smart wallet determines the potential outcome for using this payment option to pay for the sales transaction. As noted above, the potential outcome reflects advantages and/or disadvantages and could include: cost savings, frequent flyer miles being reward, cash back, etc. The smart wallet app saves the results of the determination. The result is saved, for example, in a temp outcome database 900 of the smart wallet, for example, that depicted in FIG. 9. Process continues to segment S5108.

In Segment S5108, the application determines, again, if the payment option is available. For example, using this payment option would exceed the purchasing threshold of the payment option making the payment option unavailable. If the payment option has become not available, then its entry is removed from the temp outcome database and the process continues to segment S5110.

In Segment S5110, the smart wallet app determines if there are any payment options left in the smart wallet database, e.g., FIG. 8, that have not been had their outcome determine. If yes, the process continues to Segment S5100 with the next option the database. If all of the payment options have been processed, then process continues to Segment 5116.

In Segment S5116, then this process ends and the process continues to Segment S1110 of FIG. 3, where the results, e.g., temp outcome database of FIG. 9, is provided to the user and the user selects the option he would like to pay with.

FIG. 9 depicts an exemplary embodiment of a temp outcome database 900 that results from the processing of payment options with respect to FIG. 3. FIG. 9 has three entries 910c, 910d, and 910e depicting three payment options and their respective potential outcome for using the payment option for making the purchase currently in process. For example, the Smart Wallet app determines that:
for the first payment option 910c, a Discover card, that the payment option provides three percent cash back on purchases. If the current purchase is for $517, then the user would receive $15.53 cash back from Discover.
for the second payment option 910d, a Citi Visa card, that the payment option provides a Frequent Flyer mile for every dollar or portion thereof, purchased. If the current purchase is for $517, then the user would receive 518 frequent flyer miles.
for the third payment option 910e, a National Federal Credit Union debit card, that the payment option provides one percent cash back on purchases. If the current purchase is for $517, then the user would receive $5.17 cash back from the Credit union.

Temp outcome database did not include entries for American Express and for ABC as these payment options were not available (as they respectively not accepted by the institution).

In another aspect, the smart wallet application provides the consumer with the option of using multiple payment methods for paying for the transaction. For example, if the consumer is making a purchase at home depot, he would like to use the remaining balance on his gift card that is stored in the mobile communication device 100 and pay the rest by his credit union credit card.

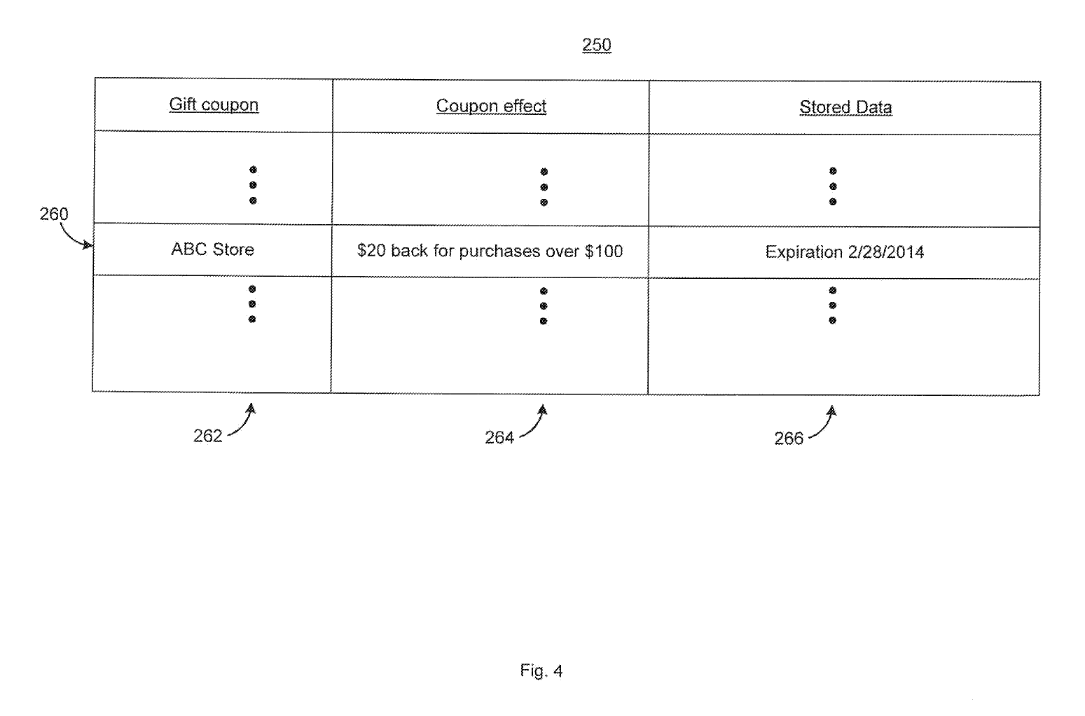

In another aspect of the invention, the smart wallet includes a coupon database. FIG. 4 depicts a coupon database 250 that would be stored in a consumer's mobile communication device 100. Database 250 includes three data fields: gift coupon 262, coupon effect 264, and other stored data 266. For example, in data entry 260, the gift coupon is for use in an ABC store. The effect of using the coupon in the ABC store is $20 back on a purchase over $100. In the stored data entry 266, the coupon expires Feb. 28, 2014.

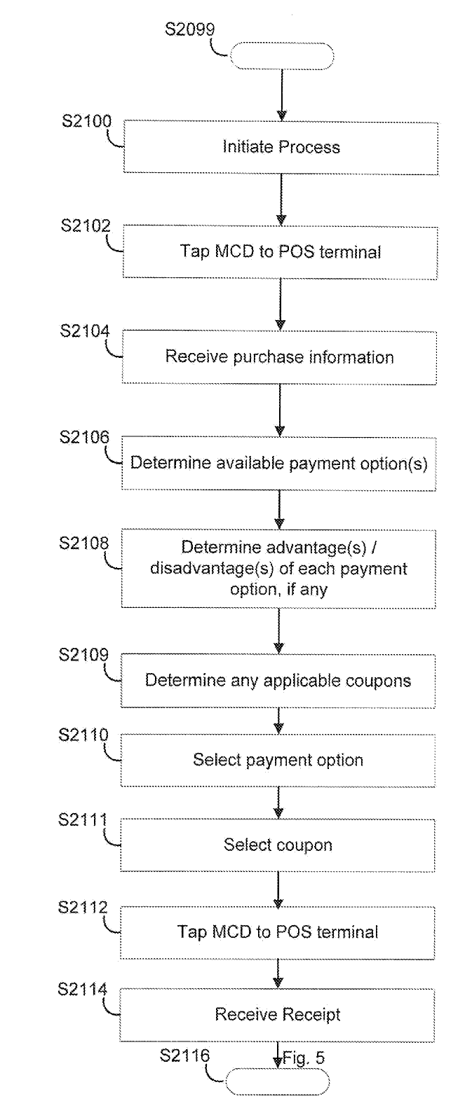

FIG. 5 a flow chart depicting another exemplary use of the invention. In segment S2099, a consumer desires to conduct a transaction in an institution 115 and has selected the merchandise and the transaction is ready to be concluded by payment by the consumer. Process continues to segment S2100.

In segment S2100 the payment process is initiated on the mobile communication device 100. The payment process is a smart wallet application on the mobile communication device 100 for at least the purposes making payment in a transaction. The application is initiated either by the consumer performing some action on the mobile communication device 100 or by some automatic trigger. Process continues to segment S2102.

In segment S2102, the consumer places the mobile communication device 100 sufficiently close to the POS terminal 110 of the institution 115 to establish communications. Process continues to segment S2104.

In segment S2104, the mobile communication device 100 receives purchase information from the institution 115. The purchase information includes, at least some uniquely defined information concerning the purchase, the purchaser, the store, the items being purchased, or the amount of the transaction, The purchase information could also include identification of the institution. Purchase information could also include payment options that are accepted and not accepted. For example, American Express may not be accepted by the institution. Process continues to segment S2106.

In segment S2106 the smart wallet application goes through each payment option in the database 200 to see if it is available for purchase. The smart wallet application relies on information stored in the database or communicates with the institutional server 105 associated with the institution 106 of the payment option or a combination of both approaches to determine information about that payment option or options. This information is used in determining advantages, disadvantages, restrictions, and allowance of use of specific payment options available for that consumer in their smart wallet. Process continues to segment S2108.

In segment S2108 the smart wallet application determines whether there is an advantage or disadvantage to using each of the available payment options for the purchase. An advantage/disadvantage may be general or specific to the store, specific consumer, items of purchase, amount, or other aspects involved in that specific purchase transaction. After determining any advantage/disadvantage, restrictions or allowances for each payment option, process continues to segment S2109.

In segment S2109, the smart wallet application examines the coupon database 250 for applicable coupons. Typically, the smart wallet application would look for a coupon(s) that correspond to the institution 115. For example, for purchases at ABC store, the smart wallet looks for coupons from the ABC store. In another approach, the smart wallet application receives item information as part of the purchase information for each item intended to be purchased. The smart wallet application looks for coupons applicable to item(s) intended to be purchased. For example, for a grocery store purchase, the purchase information includes store brand milk and store brand eggs. The smart wallet application examines the coupon database 250 for item specific coupons. Process continues to segment S2110.

In segment S2110, the consumer selects a payment option. Process continues to segment S2111.

In segment S2111, the consumer selects a coupon option, if available and if desired. Process continues to segment S2112.

In segment S2112, the consumer places the mobile communication device 100 sufficiently close to the POS terminal 110 of the institution 115 to establish communications. As part of the communications, the mobile communication device 100 provides payment information for the selected payment option. If applicable, the mobile communication device 100 also provides coupon information. Process continues to segment S2114.

In segment S2114, the institutional server 112 receives the payment information, processes the payment and provides a receipt to the consumer through a designated method. Process continues to segment S2116.

In segment S2116, payment has been made and the process ends.

Thus, smart wallet application has provided the consumer with available payment options, advantage/disadvantage of each payment option and has made a selection of the payment option to be used for the transaction based on the information provided by the smart wallet and that payment option information was provided to the institution 115 so as to conclude the transaction.

In another exemplary approach, a consumer can add a new payment option as part of transaction. Similar to the approach above, however, when a smart wallet app receives purchase information it will check to see if it has a payment option associated with the institution of the transaction. For example, if the purchase information indicates that the transaction is taking place at Macy's, the Smart Wallet application will check to see if there is a Macy's credit card in the payment option database. If there is not a payment option associated with the institution of the transaction, then the Smart Wallet application will determine whether a payment option is available. For example, the smart wallet application will contact the Macy's server to see if a payment option exists. If there is a payment option, then the Smart Wallet will provide the option to consumer so that the consumer will determine whether they want to apply for the payment option. Preferably, the smart wallet will also determine if there are advantages if the Macy's payment option is used to pay for the transaction. These advantages will be provided to the consumer to help assist her decision about applying for the payment option. If the consumer decides to apply for the card, then the smart wallet establishes communication with the institution of the transaction, and enables the consumer to apply for the payment option through her mobile communication device. After the payment option application has been completed, and presumably approved for use, then the Macy's payment option is added to the payment option database 200.

After the consumer has had the opportunity to apply for a payment option, then the Smart Wallet then proceeds with the payment process outline above, for example, at Segment S1106/S2106, at examines the available payment options. If a payment option was just added, this new payment option is part of database 200 and is also examined by the Smart Wallet.

As such, a consumer can add a new payment option to the payment options stored in the smart wallet during a purchase transaction.

In another example, a coupon stored coupon in the smart wallet can dynamically be modified, so as to motivate the consumer at the moment of purchase to use a specific coupon. For example, a stored coupon has the effect of 10% off a purchase valued at $100 or more. The dynamic modification can change the coupon effect at the time of the purchase. For example, the coupon effect is modified if the consumer is intending to purchase more than $50 but less than $100 so that consumer is offered 10% off purchases valued at least $50. The store provides the modification because the store recognizes the consumer and identifies them to be a loyal customer.

In another scenario of dynamic modification of a coupon, loyalty card, or discount, the consumer has purchased $180 worth of items and will be using the 10% coupon for purchases of over $100. The system can dynamically offer to give the consumer a 15% discount if they add additional items to their purchase, for the purchase to total more than $200. There by motivating the consumer to purchase last minute items, and dynamically motivating them with benefits in doing so. These benefits can include dynamically modified coupons, dynamically modified loyalty points values, dynamically modified prizes, and dynamically modified discounts, which are all currently offered to the consumer and stored in their mobile device or associated with the consumer in a virtual account or accounts.

In another aspect of the invention, the consumer maybe offered a last minute deal on a specific item if they purchase it right then and there. For example, a store is discontinuing an item and the consumer, based on information about the consumer, is seen as able to be motivated to purchase this soon discontinued item. At the point of purchase, the smart wallet can inform the consumer of the item and offer a discount if they choose to add this item to their purchase today, if they select to purchase that item right then and there. This allows retailers a new method of selling specific items for specific consumers who are most likely to buy those items and at the moment where they are most likely to be influenced by impulse buying.

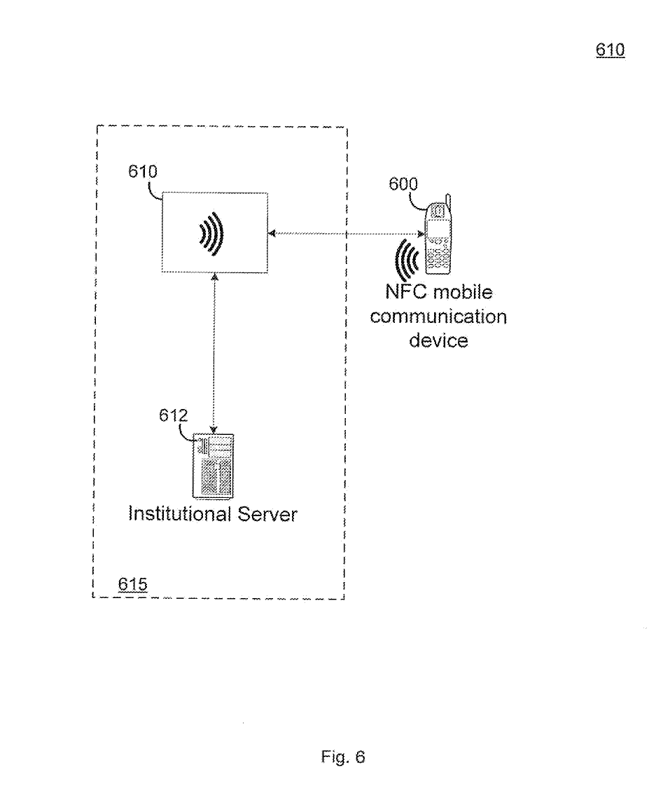

FIG. 6 depicts a payment scenario according to another exemplary embodiment of the invention. As seen in FIG. 6 the scenario is a mobile communication device 600, an institution 615, a POS terminal 610, and an institutional server 612. The mobile communication device 600 includes at least NFC communication abilities and cellular communication abilities. The mobile communication device 600 is enabled to communicates with its associated cellular server through a tower.

Institution 615 is representational of a transaction party that is interacting with a consumer through the consumer's mobile communication device 600 to conduct a transaction—e.g., a purchase of an item(s). Institution 615 includes at least one POS terminal 610 which includes NFC capabilities. The POS terminal 610 communicates with an institutional server 612. Although shown as a single POS terminal 610, this is representational of a single or network of POS terminals associated with the institution 615. Although shown as a single institutional server 612, this is representational of a single or network of institutional servers associated with the institution 615. In another approach, a point of sale system incorporates a NFC reader 610 to receive payment from a consumer. When electronic payment is received from a consumer the point of sale system communicates that information to an associated financial institution which processes the payment and provides electronic payment to an account(s) associated with the institution where the point of sale device is employed.

In use, a consumer with a mobile communication device 600 desires to make a purchase from an institution 615. The consumer selects a payment option on his mobile communication device 600 and provides payment information to the institution by way of the consumer's mobile communication device 600 electronically communicating with the institution's POS terminal 610, preferably using NFC communications.

In order for a consumer to make a payment using his mobile communication device 600, the mobile communication device 600 would preferably have payment options stored in an electronic data file, e.g., a smart wallet, in the mobile communication device 600.

In an exemplary approach of the use of the approach of FIG. 6, different from the example described with reference to FIG. 1, the smart wallet application relies on data stored within the mobile communication device 600 to provide payment assistance to the consumer. The smart wallet does not contact institutions associated with the payment options.

While the invention has been described and illustrated with reference to specific exemplary embodiments, it should be understood that many modifications, combinations, and substitutions can be made without departing from the spirit and scope of the invention. For example, an operation described as occurring in software is not necessarily limited to be implemented in software and can be partially, substantially, or completely implemented in hardware. Similarly, an operation described as occurring in hardware is not necessarily limited to be implemented in hardware and can be partially, substantially, or completely implemented in software. Furthermore, although NFC is used in several of exemplary aspects described above, the invention is not so limited and other communication technologies can be utilized, for example, but not limited to, barcodes, Bluetooth, and Wi-Fi. Furthermore, while exemplary aspects depict an invention using a mobile phone as a type of mobile communication device, the invention is not so limited and can be other types of computing devices, for example, but not limited to, a tablet computer, laptop computer, a personal computer and any other computing device that a consumer can use. Accordingly, the invention is not to be considered as limited by the foregoing description but is only limited by the scope of the claims.

What is claimed as new and desired to be protected by Letters Patent of the United States is:

1. A method for selecting an advantageous method for paying for a transaction at an institution, comprising:
receiving purchase information;
determining available payment options;
determining advantages of using available payment options; and
selecting a payment option from said available payment options.

2. The method of claim 1, wherein the segment of determining available payment options further comprises the segment of:
examining stored payment options;

3. The method of claim 1, wherein the segment of determining available payment options further comprises the segment of:
determining whether a payment option is accepted at the institution.

4. The method of claim 3, wherein the segment of determining available payment options further comprises the segment of:
determining whether a payment option will exceed a threshold.

5. The method of claim 3, wherein the segment of determining advantages of using available payment options further comprises the segment of:
determining a general advantage of using a payment option.

6. The method of claim 5, wherein the segment of determining advantages of using available payment options further comprises the segment of:
determining a specific advantage of using a payment option based on said purchase information.

7. A system for selecting an advantageous method for paying for a transaction at an institution, comprising:
a mobile communication device having a stored program that when executing, performs the segments of:
receiving purchase information;
determining available payment options;
determining advantages of using available payment options; and
selecting a payment option from said available payment options.

8. The system of claim 7, wherein the segment of determining available payment options further comprises the segment of:
examining stored payment options;

9. The system of claim 7, wherein the segment of determining available payment options further comprises the segment of:
determining whether a payment option is accepted at the institution.

10. The system of claim 9, wherein the segment of determining available payment options further comprises the segment of:
determining whether a payment option will exceed a threshold.

11. The system of claim 9, wherein the segment of determining advantages of using available payment options further comprises the segment of:
determining a general advantage of using a payment option.

12. The system of claim 11, wherein the segment of determining advantages of using available payment options further comprises the segment of:
determining a specific advantage of using a payment option based on said purchase information.

13. The system of claim 11, where said mobile communication device is further programmed to perform the segment of:
acquiring attribute information of a payment option.

14. The system of claim 11, where said mobile communication device is further programmed to perform the segment of:
receiving an additional payment option from said institution.

15. The system of claim 14, wherein said segment of determining advantages of using available payment options includes said additional payment option.

16. The system of claim 11, wherein the segment of selecting a payment option from said available payment options further comprises the segment of:
determining whether a coupon should be used as at least partial payment.

17. The system of claim 11, wherein the segment of selecting a payment option from said available payment options further comprises the segment of:
determining whether a combination of payment options should be used to pay for the purchase.

18. A system for selecting an advantageous method for paying for a transaction at an institution, comprising:
a computer system associated with said institution where a user desires to make a purchase using a mobile communication device, the computer system having a stored program that when executing, performs the segments of:
providing to said mobile communication device purchase price;
providing to said mobile communication device purchase information; and
receiving from said mobile communication device payment information.

19. The system of claim 18 wherein said segment of providing to said mobile communication device purchase information further comprises the segment of:
providing a specific advantage of using a payment option.

20. The system of claim 18 further comprising the segment of:
processing said purchase using said payment information.
